(19) United States
(12) Patent Application Publication
(10) Pub. No.: US 2013/0180171 A1
(43) Pub. Date: Jul. 18, 2013

(54) Systems and Methods for Harvesting and/or Analyzing Biological Samples

(71) Applicant: Kevin Oldenburg, Spokane, WA (US)

(72) Inventor: Kevin Oldenburg, Spokane, WA (US)

(21) Appl. No.: 13/738,812

(22) Filed: Jan. 10, 2013

Related U.S. Application Data
(60) Provisional application No. 61/586,379, filed on Jan. 13, 2012.

(51) Int. Cl. A01G 31/02

(52) U.S. Cl. CPC A01G 31/02
USPC 47/63

(57) ABSTRACT

Systems for harvesting biological samples are provided that can include a first multi-well plate configured to support the growth of individual biological material within one or more of first wells of the first plate; and a second multi-well plate configured to couple with the first plate.

Methods for harvesting biological samples are provided that can include providing first and second complimentary multi-well plates; growing individual biological material within the first plate; separating the individual biological material into first and second portions; and providing at least some of the second portion of the individual biological material into the second wells while maintaining at least some of the first portion within the first wells.

Complimentary multi-well plates configured to couple in a stacked configuration are provided that can include a top plate having one or more open-bottomed wells and a bottom plate comprising one or more close-bottomed wells.

### CROSS REFERENCE TO RELATED APPLICATION

This application claims priority to U.S. Provisional Patent Application Ser. No. 61/586,379 which was filed on Jan. 13, 2012, the entirety of which is incorporated by reference herein.

### TECHNICAL FIELD

The present disclosure relates to systems and methods for harvesting and/or analyzing biological samples. In particular embodiments, the systems can include multi-well plates for use in harvesting and/or analyzing biological material.

### BACKGROUND

Multi-well plates have been utilized as an apparatus to facilitate high throughput assays of biological material. The present disclosure provides systems and methods for harvesting and/or analyzing biological samples.

### SUMMARY

Systems for harvesting biological samples are provided that can include a first multi-well plate configured to support the growth of individual biological material within one or more of first wells of the first plate; and a second multi-well plate configured to couple with the first plate and receive a portion of each of the individual biological material within one or more of the second wells of the second plate.

Methods for harvesting biological samples are provided that can include providing first and second complimentary multi-well plates, the first plate having one or more open-bottomed first wells, and the second plate having one or more second wells; growing individual biological material within one or more of the first wells of the first plate, at least some of the material extending into one or more of the second wells of the second plate; separating the individual biological material into first and second portions; and providing at least some of the second portion of the individual biological material into the second wells while maintaining at least some of the first portion within the first wells.

Complimentary multi-well plates configured to couple in a stacked configuration are provided that can include a top plate having one or more open-bottomed wells and a bottom plate comprising one or more close-bottomed wells.

### BRIEF DESCRIPTION OF THE DRAWINGS

Embodiments of the disclosure are described below with reference to the following accompanying drawings.

FIG. 1 is a system at one stage for harvesting and/or analyzing biological samples according to an embodiment.

FIG. 2 is the system of FIG. 1 at a subsequent stage according to an embodiment.

FIG. 3 is the system of FIG. 2 at a subsequent stage according to an embodiment.

FIG. 4 is a multi-well growth plate according to an embodiment.

FIG. 5 is a cross-section of the multi-well growth plate of FIG. 4 according to an embodiment.

FIG. 6 is a bottom view of the multi-well growth plate of FIG. 4 and

FIG. 5 according to an embodiment.

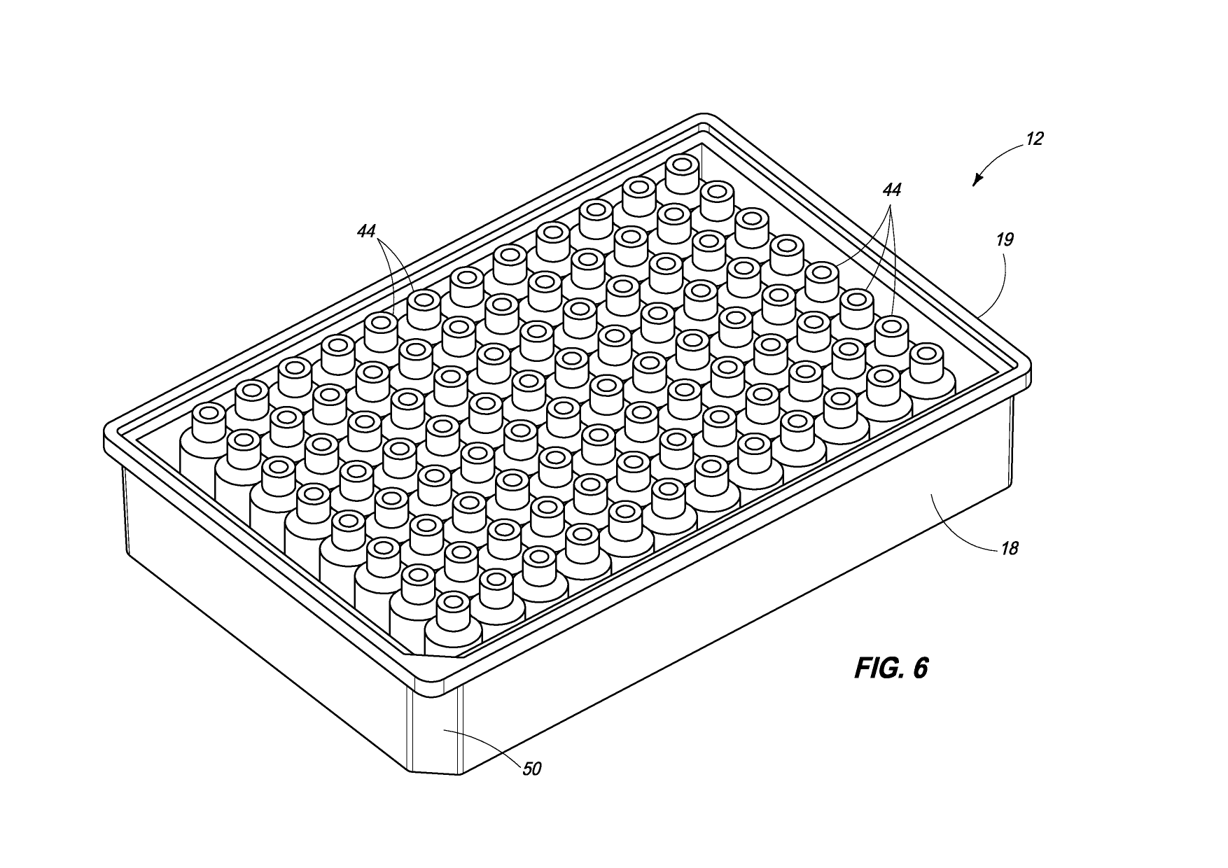

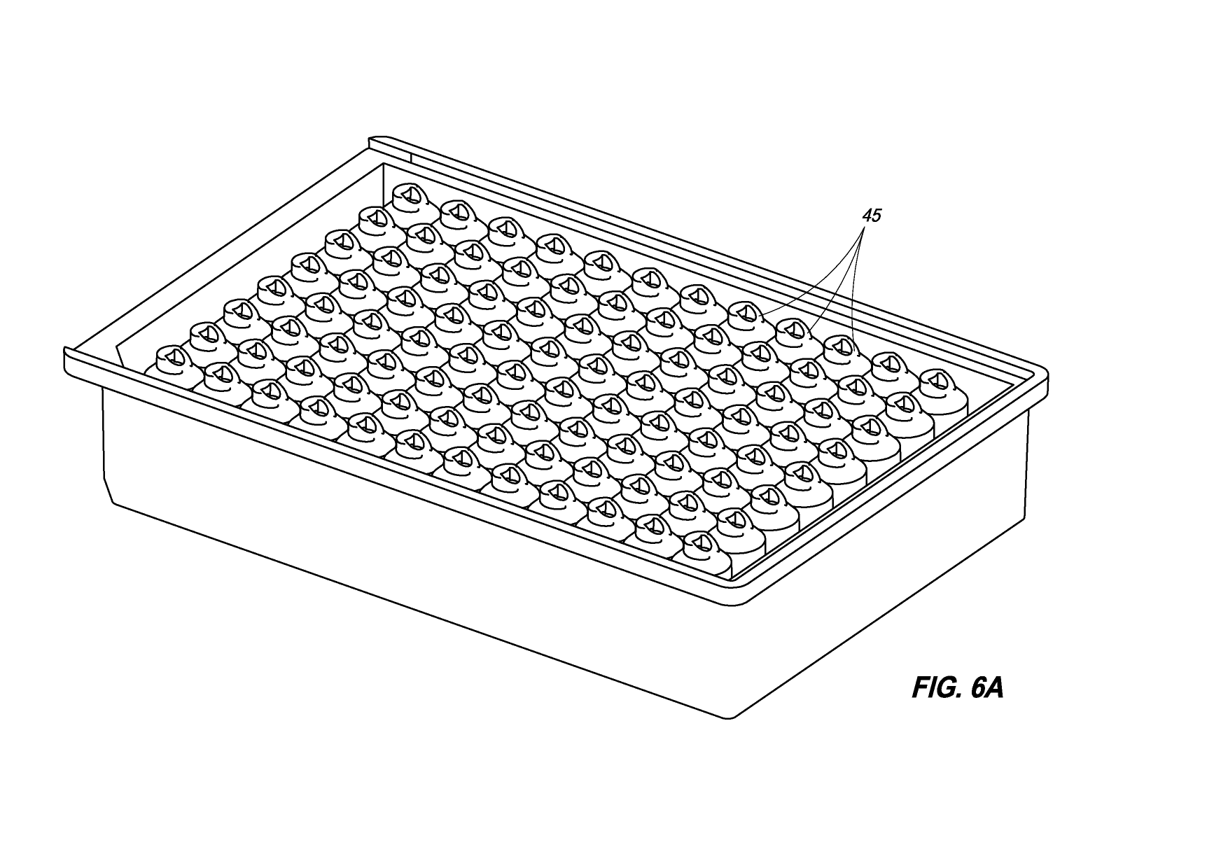

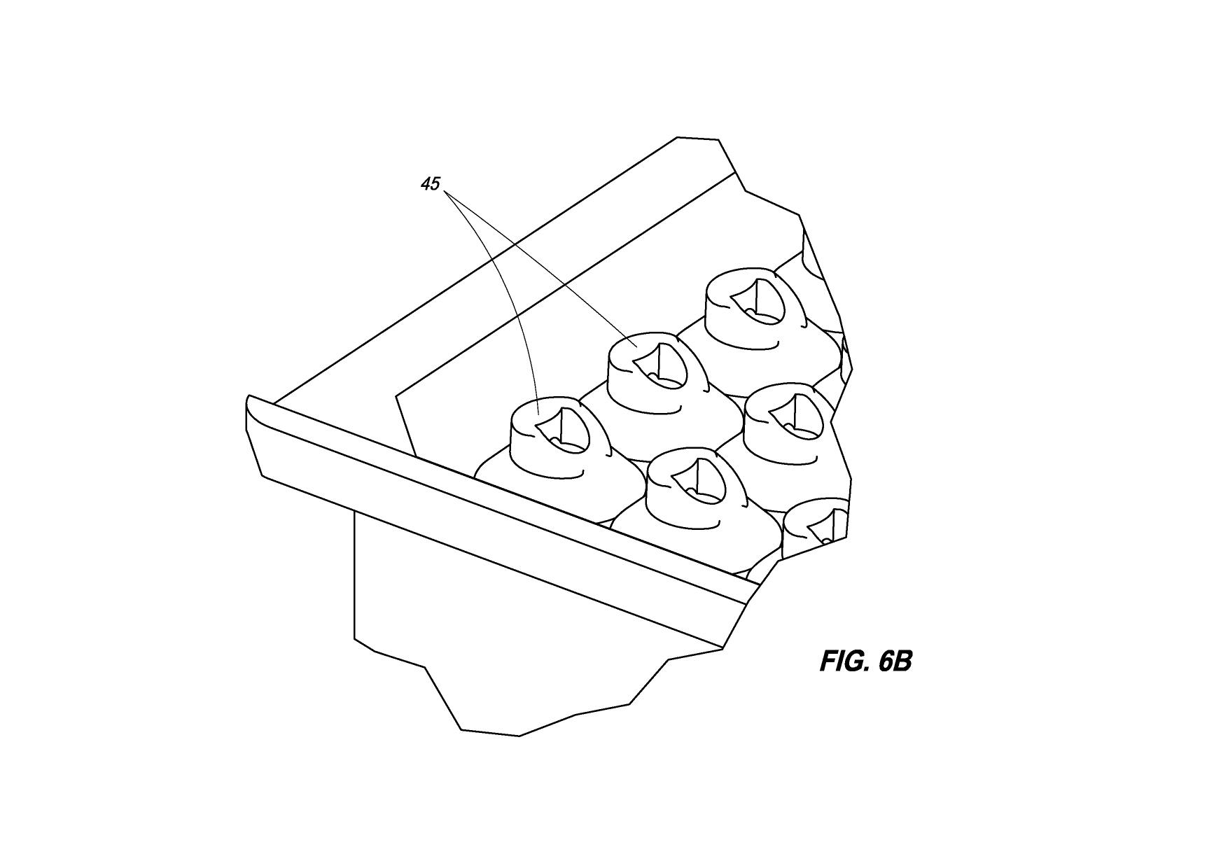

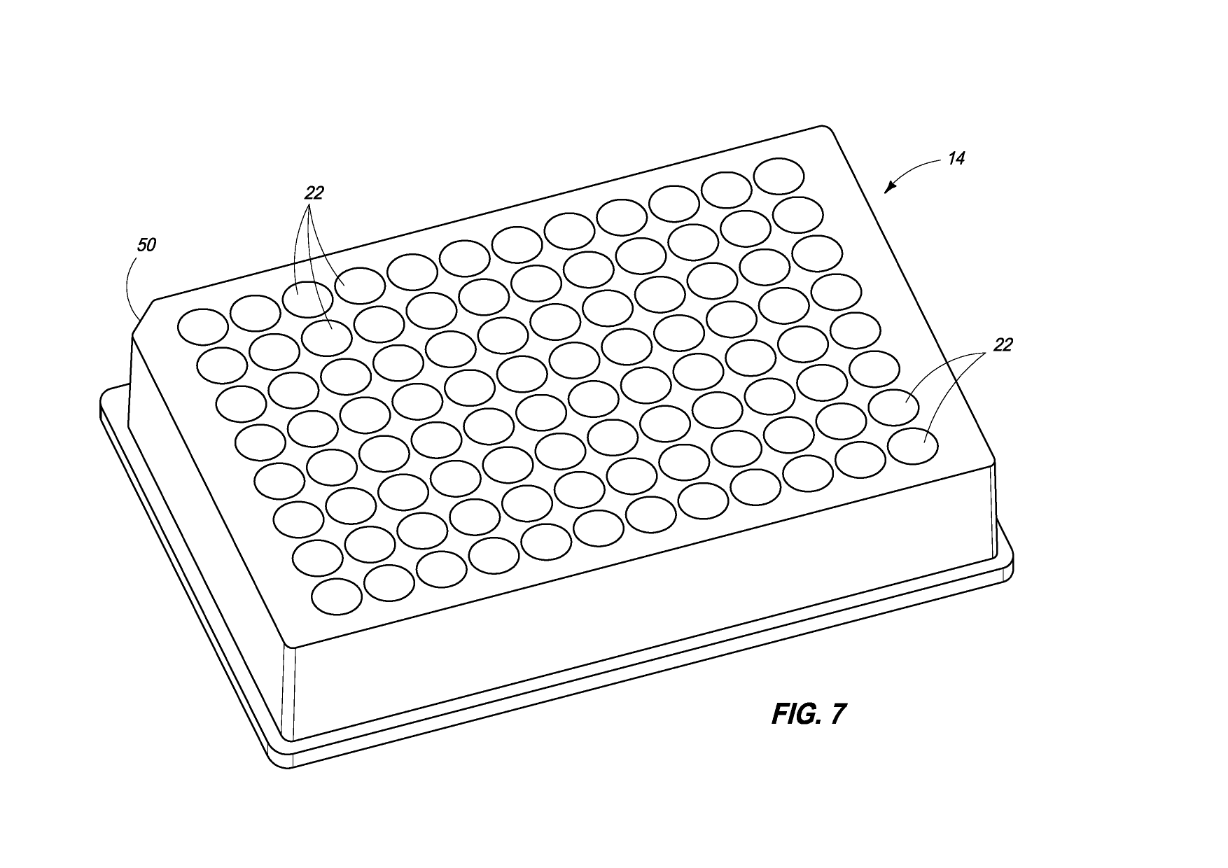

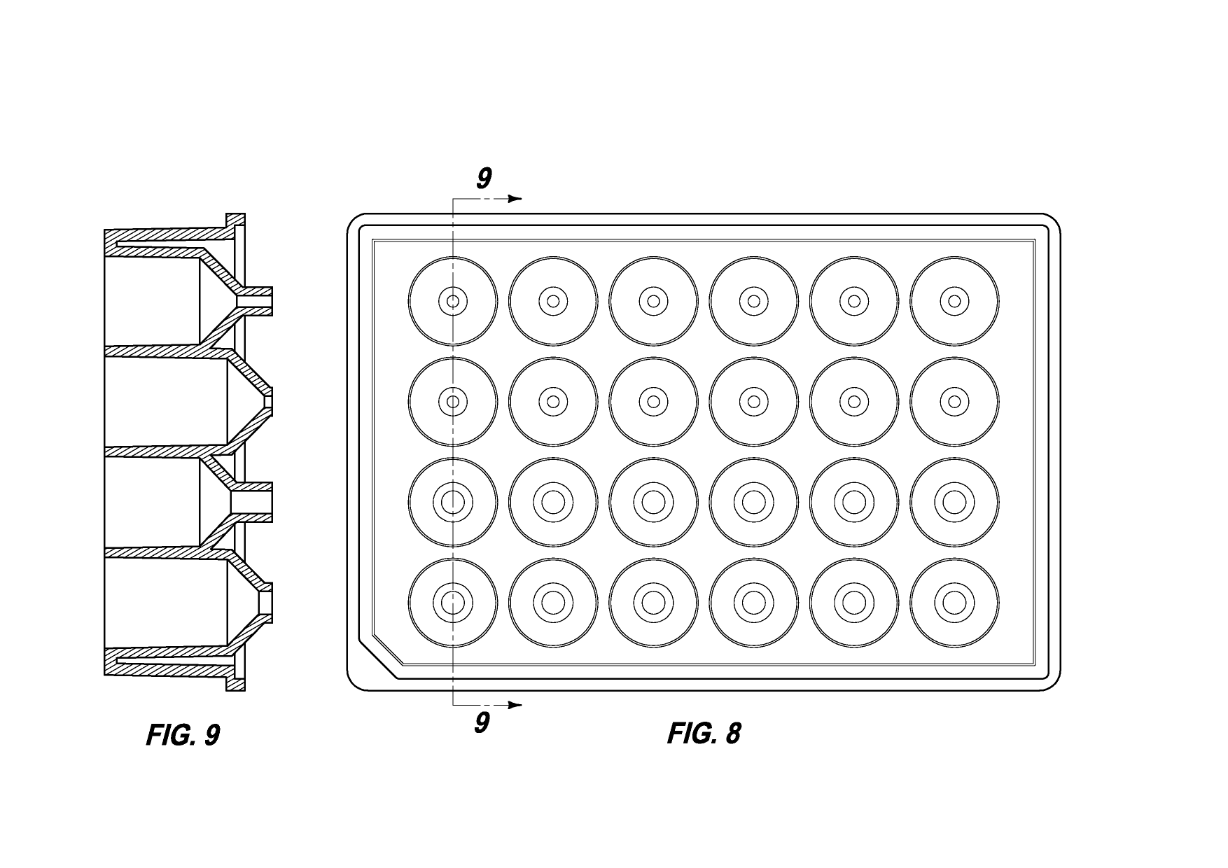

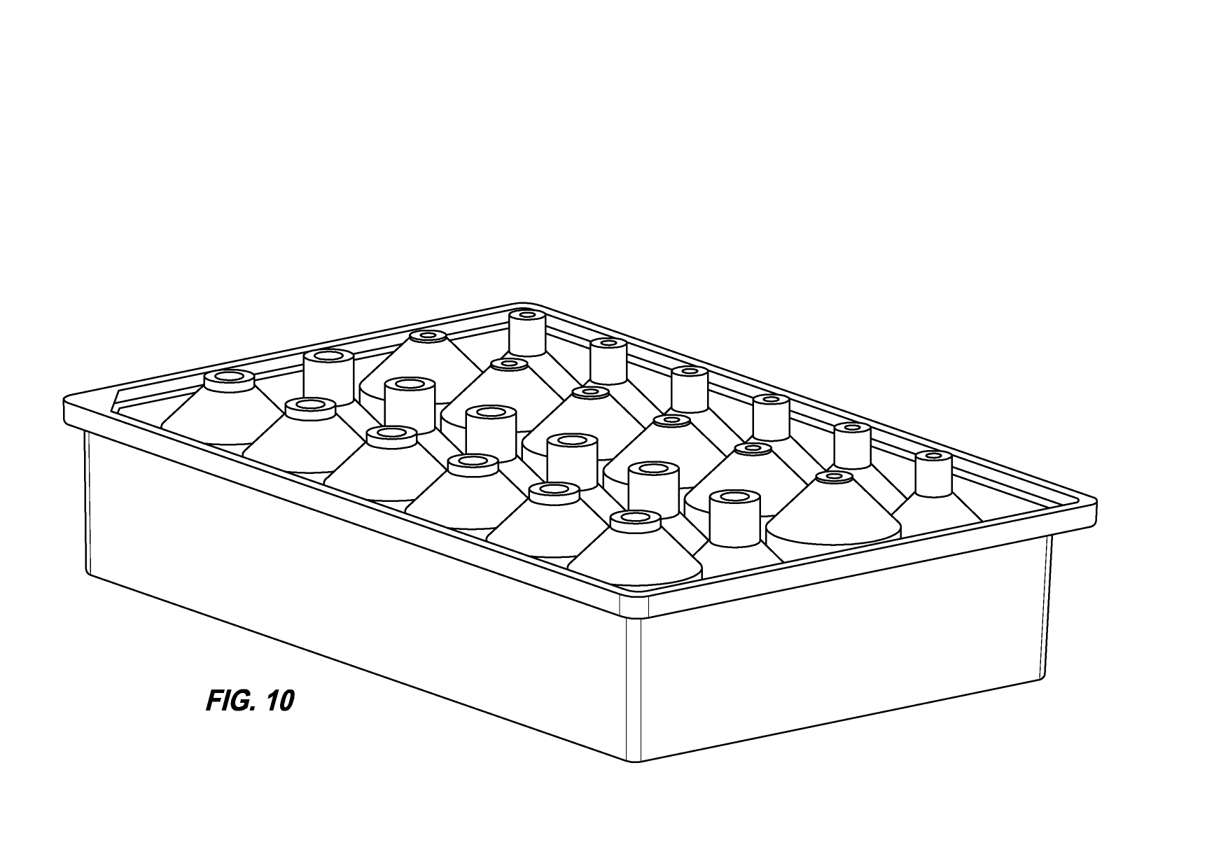

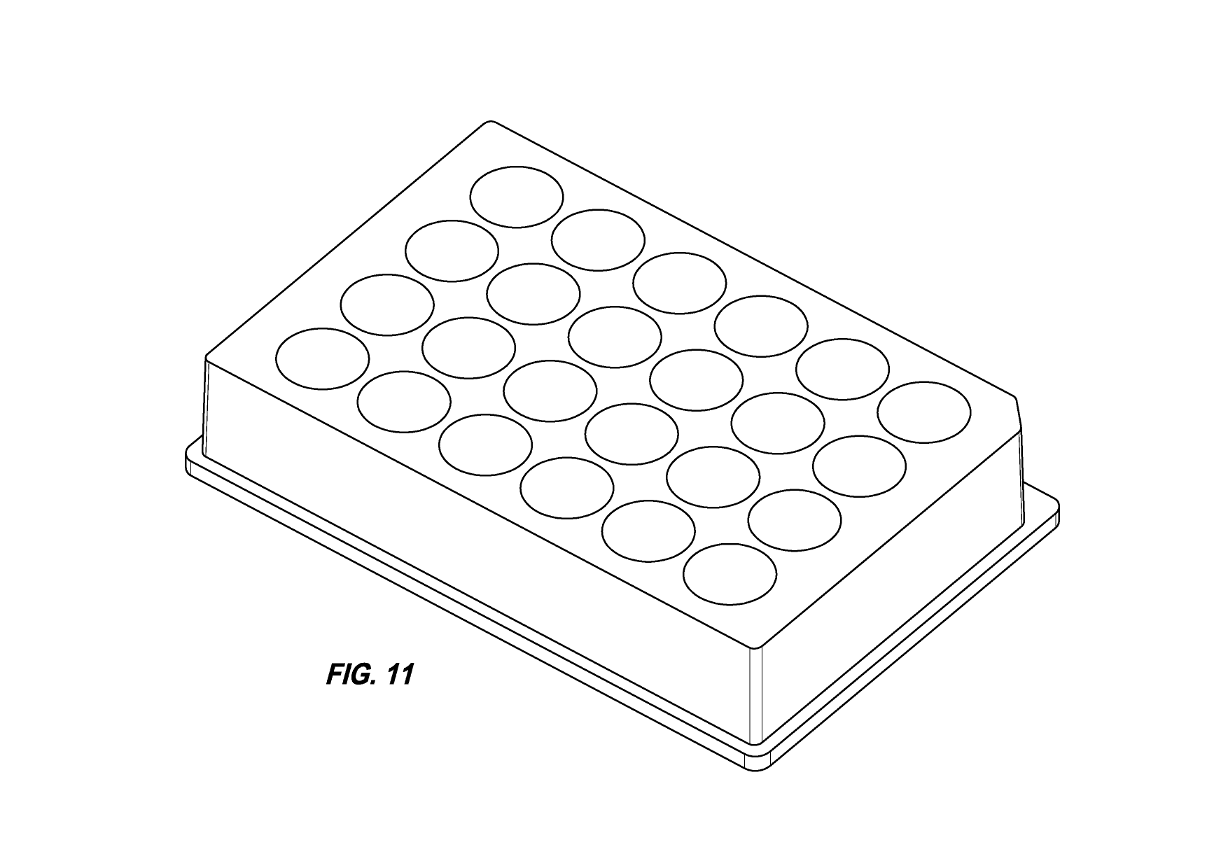

FIGS. 6A & B are multi-welled growth plate views according to an embodiment.

FIG. 7 is a top view of a multi-well reservoir plate according to an embodiment.

FIGS. 8-11 are views of alternative embodiments of a multi-well plate for use in systems and methods of the disclosure.

### DESCRIPTION

This disclosure is submitted in furtherance of the constitutional purposes of the U.S. Patent Laws “to promote the progress of science and useful arts” (Article 1, Section 8).

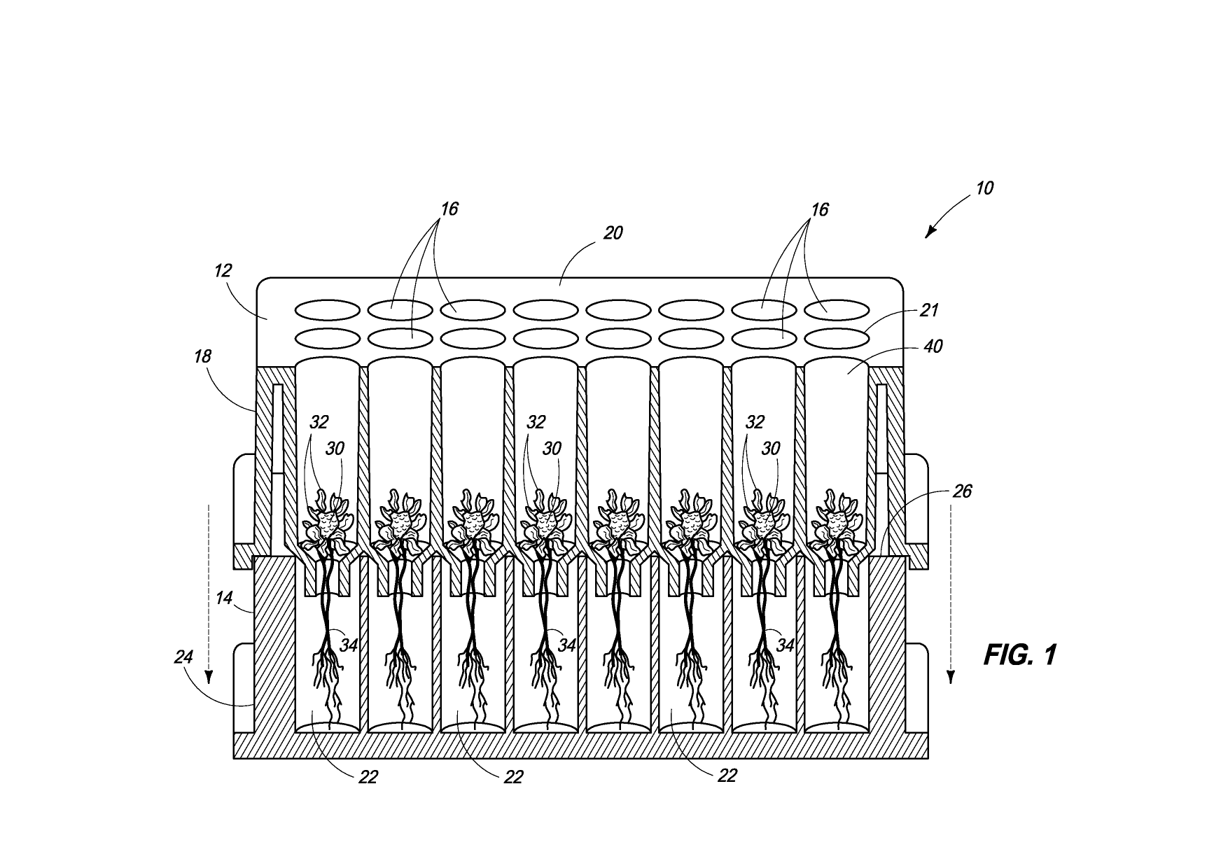

The systems and methods of the present disclosure will be described with reference to FIGS. 1-11. The materials of construction and methods of making the multi-well plates of the present disclosure can be found in U.S. patent application Ser. No. 12/146,869 filed Jun. 26, 2008, entitled “Multi-Well Reservoir Plate and Methods of Using Same”, published Jan. 1, 2009 as United States Patent Application 20090004754, the entirety of which is incorporated by reference herein.

As an example, the multi-well plates of the present disclosure can be square, rectangular, circular, triangular, elliptical, or any other configuration.

The plates can be made from glass, quartz, metal, plastic, such as polystyrene or polypropylene, polyolefins, such as cyclo-olefin polymer or cyclo-olefin copolymer. Plates may also be made from at least one of the above-identified materials as described in U.S. Pat. No. 6,232,114, for example.

Plates may be fabricated to be resistant to degradation or deterioration from dimethylsulfoxide (DMSO), formamide, formaldehyde, alcohols, acids, bases, or other chemicals. In one embodiment, plates can be sterile and/or may be sterilized before each use. In another embodiment the plates can be RNAse and/or DNAase and/or protease free.

Plates can be fabricated from a material that is opaque and/or has a low luminescence or fluorescence. By way of example, the plates may be made from a material that exhibits an autofluorescence at screening wavelengths at or below about 5% of the signal observed from the assay. Exemplary screening wavelengths employed that are typically used for screening purposes are 337 nanometers (nm), 360 nm, 400 nm, 405 nm, 430 nm, 460 nm, 480 nm, 485 nm, 520 nm, 535 nm, and 590 nm, however other values may also be used. Additionally or alternatively, the plate can be made from a material that may reduce or even substantially block the transmission of light. In another embodiment, the material of the plate can provide a background that may augment and/or be beneficial with optical detection and/or activation methods. In still other embodiments, the plate may be constructed of material that facilitates plant growth, such as a clear or even translucent material.

In one embodiment, the plates can include a covering that is pigmented. One type of pigment that may be used for the covering is carbon black.

Wells or other portions of the plates may be coated with at least one chemical, biological reagent, and/or factor. Coatings may be applied by any suitable method, including printing, spraying, radiant energy, ionization, dipping, stamping, pressing, adhering, derivatizing a polymer, etching, chemical reaction, any combination thereof or other contact. For example, derivatized polymers may be reacted with a selected chemical moiety such that a covalent or non-covalent attachment occurs. Chemical moieties may vary depending on the application, but may include binding partners, solid synthesis components for amino acid or nucleic acid synthesis, or cell culture components.

Alternatively, the wells of the plates may be coated with chemicals or other materials for a variety of purposes. For example, some purposes of the coatings may be to increase or decrease surface tension, to decrease or prevent oxidation, and/or to decrease or prevent plate degradation. In one embodiment, the wells can be coated with silicone or Teflon® (polytetrafluoroethylene), to render the surface more hydrophobic. In another embodiment, the wells can be coated with an epitope tag, such as glutathione or coated with an extracellular matrix component, such as fibronectin, collagen, laminin, or other similar or equivalent substance. In yet another embodiment, the wells can coated with at least one poly-L or poly-D amino acid, biotinylated molecules, such as streptavidin, a resin, a polymer, a silica gel, a matrix or other chemical. The resin, polymer, silica gel, matrix or other chemical may operate as a separation gradient for the substance in the wells. Alternatively, the resin, polymer, silica gel, matrix or other chemical may operate as a carrier of another biological or chemical agent, such as bifunctional heterocycle, heterocyclic building block, amine, alcohol, carboxylic acid, sulfonyl chloride, or other agent. In yet another embodiment, the wells can be coated with at least one radioisotope.

The plates may be fabricated from at least one liquefied material, such as polystyrene, which is then cooled in a mold to form the multi-well reservoir plate. Alternatively, the multi-well reservoir plate may be made by pressing and/or stamping a sheet material, such as a metallic sheet material, to at least form the wells in the plate, such as a metallic sheet.

Referring first to FIG. 1, a system 10 is shown that includes a first multi-well plate 12. Multi-well plate 12 can be a multi-well growth plate, for example. Plate 12 can be configured to support the growth of individual biological material within one or more of its wells. Plate 12 can include wells 16, for example, that are defined by openings within upper plate 20 of plate 12. Wells 16 within plate 12 can be referred to as first wells within a plate 12, or first plate 12. Each of the plates can be comprised of wells (1 to 9600 but typically 6, 12, 24, 48, or 96). One or more of wells 16 can be open-bottomed. Plate 12 can have a frame 18 that defines its perimeter.

System 10 can further include a second plate 14 such as a multi-well reservoir plate or a single well plate or trough. This plate can have wells 22 that compliment wells 16 of plate 12. Wells 22 can be referred to as second wells within plate 14, or second plate 14. Multi-well reservoir plate 14 can have an upper plate 26 defining wells 22 therein, and have a frame 24 defining a perimeter extending therearound. Both frames 18 and frames 24 can engage and/or couple one another, as wells 16 and 22 engage and/or couple one another providing for the alignment of same when stacked for example. One or more of wells 22 can be close-bottomed.

Second plate 14 can include wells 22 that define openings 17 configured to receive at least a portion of wells 16 upon alignment of plate 12 with plate 14. Wells 16 can include at least one sidewall 40 extending from edge 21 of surface 20 to support member 42 extending from sidewall 40.

Multi-well growth plate 12 can be configured to provide support for a biological material within one or more of wells 16. The support for the biological material can be a structural support 30 such as support for seed germination and/or growth. This structural support can be rock wool, vermiculite soil or other materials commonly used in hydroponics or seed germination. In accordance with example implementations, the color of the plates of system 10 can be dark or opaque, thereby limiting sunlight to further foster the process of seed germination.

In accordance with example implementations, multi-well reservoir plate 14 can have from 1 to 9600 wells configured to engage multi-well growth plate 12 and be placed under multi-well growth plate 12. Reservoir plate 14 can be filled with water or plant growth media. Plate 14 can have water or media so that roots do not dry out. Space may be provided between plates 12 and 14 to facilitate air exchange between the exterior of the plates and the biologic material. It may also be possible to facilitate growth of the biological material within a humid atmosphere. In accordance with example implementations, upon seed germination, roots 34 can grow down through an opening within well 16 and enter wells 22, providing for biologic material 32 to exist within wells 16.

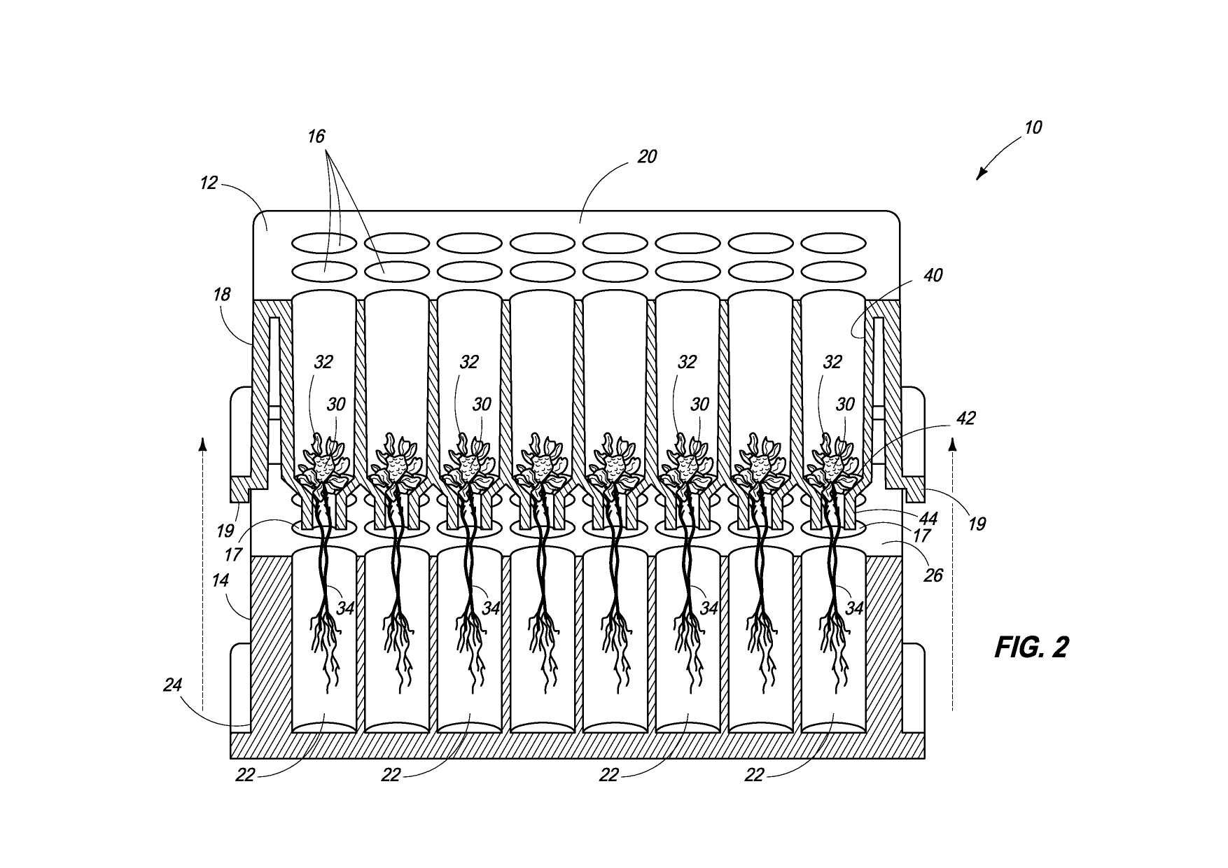

Referring next to FIG. 2, plates 12 and 14 are at least partially separated from one another. As shown, root material 34 still extends between plate 12 and plate 14 and into wells 22 from wells 16. More specifically, wells 16 can have a wall 40 extending to support member 42 which further extends to a lower wall 44. Growth media and/or biologic material 32 can be supported by member 42 and extend through conduit 44 into well 22, for example. In accordance with example implementations, this conduit can be shorter than the skirt 19 of plate 12, and/or skirt 19 can be configured to compliment plate 26 of plate 14, for example. In accordance with alternative embodiments, this conduit 44 can extend longer than skirt 19 such that it protrudes into plate 14 when coupled thereto. Accordingly, conduit 44 can be configured to axially align with well opening 16 and/or 22.

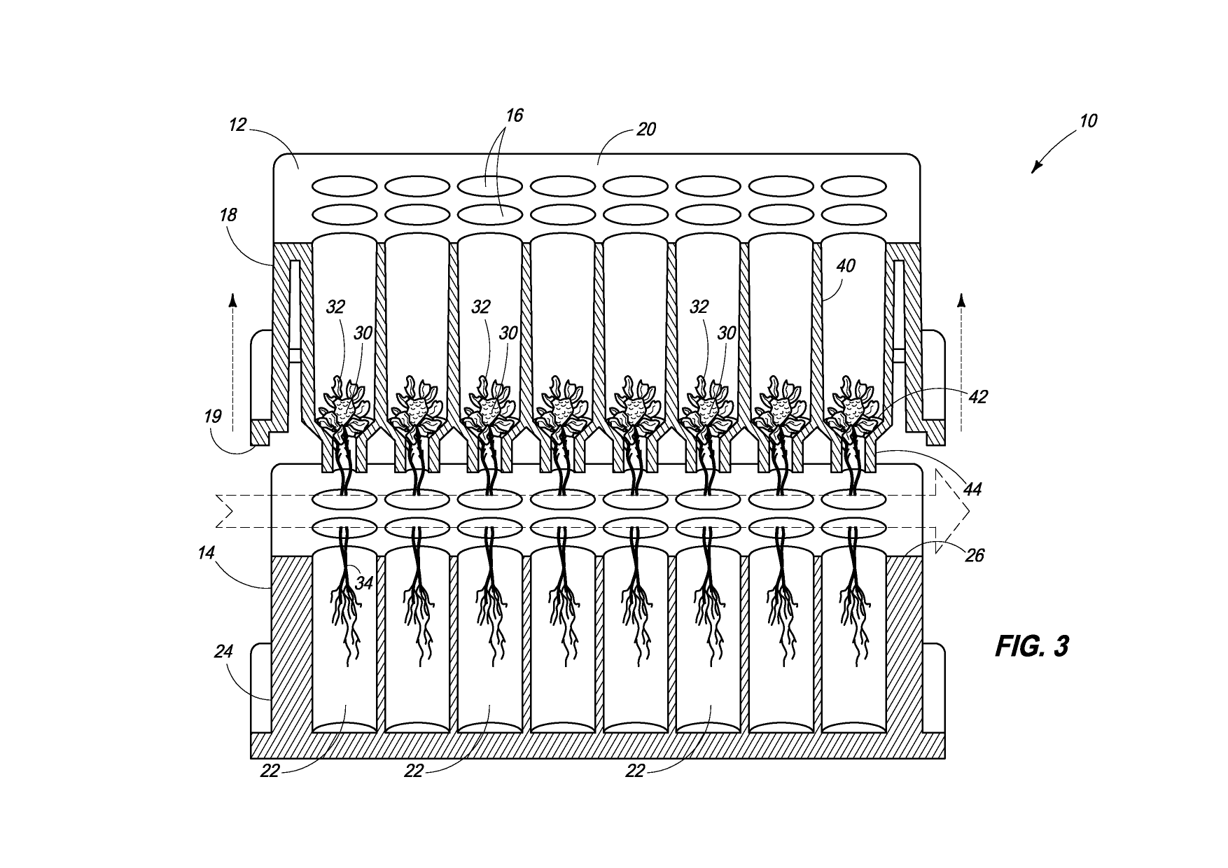

Referring to next FIG. 3, system 10 is shown at a further stage in the harvesting process that includes the separation of individual biological material into portions and/or the providing of one of the portions of the individual biological material into the other of the multi-well plates.

In accordance with example implementations, plate 14 can have the same number of wells as plate 12, and the plates can be configured such that by slightly lifting plate 12 and sliding plate 12 laterally in relation to plate 14, material 34 extending into wells 22 may be sheared off and remain in wells 22 of plate 14. In another embodiment of the disclosure, Plate 12 could have a member 45 such as a bevel/blade that is slanted such that when plate 12 is drawn across the opening of plate 14, the biological material is sheared off and deposited in plate 14 (see, for example, FIGS. 6A & B). In another embodiment, plate 12 can remain in contact with plate 14 and both plates shaken such that biological material dissociates from the biological specimen and remains in plate 14. In accordance with an alternative embodiment, separating plates 12 and 14 can provide a space there between wherein root material 34 still extends into well 22. A cutting mechanism can be inserted within the space between the two plates and material 34 sheared into portions with a portion of material 34 extending into and remaining within well 22. In another embodiment, plate 14 may have the same number of wells or fewer wells than plate 12, for example. Plate 12 can be removed in its entirety from plate 14 and placed over another plate having wells configured to receive portions of material 34, and those portions of material 34 can be sheared from plate 12 and provided to that third plate.

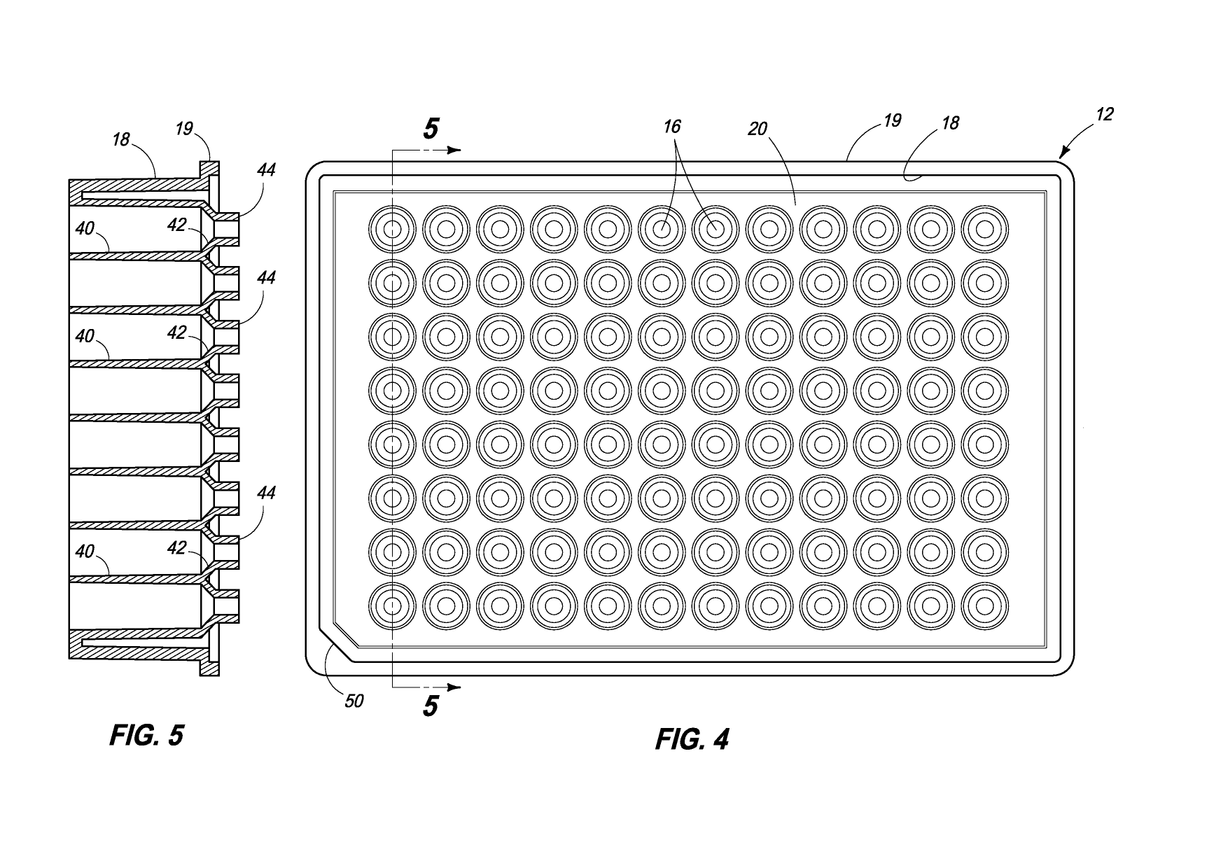

Referring to FIGS. 4-6, an upper view, cross-section view, and isometric perspective view of plate 12 is shown according to an embodiment. In accordance with example implementations, plate 12 includes an indexed portion 50 allowing the proper alignment of plate 12 with another plate having a complimentary indexed portion.

Referring to FIG. 7, an example plate 14 is shown having wells 22 and a complimentary indexing portion 50, for example. Referring to FIGS. 8-11, example configurations of different wells for use as part of a multi-well growth plate are shown having different dimension sizes and scopes.

After the biologic portion is placed within the reservoir plate, fragments of the biologic can be subjected to DNA extraction, marker analysis, or any type of DNA profiling, for example. Based on the DNA results, the corresponding plants in the multi-well plates can be pulled from their wells and replanted into larger containers for future work as desired.

In compliance with the statute, embodiments of the disclosure have been described in language more or less specific as to structural and methodical features. It is to be understood, however, that the entire invention is not limited to the specific features and/or embodiments shown and/or described, since the disclosed embodiments comprise forms of putting the invention into effect.

1. A system for harvesting biological samples, the system comprising:
a first multi-well plate configured to support the growth of individual biological material within one or more of first wells of the first plate; and
a second multi-well plate configured to couple with the first plate and receive a portion of each of the individual biological material within one or more of the second wells of the second plate.

2. The system of claim 1 wherein the biological material is plant and the portion is a root of the plant.

3. The system of claim 1 wherein the first plate defines each of the one or more of the first wells to include at least one sidewall extending from an edge of a surface of the plate to a support member extending inwardly from the sidewall.

4. The system of claim 3 wherein the support member defines an opening axially aligned with the first well opening.

5. The system of claim 4 further comprising a conduit extending from the support member, the opening of the support member defining the opening of the conduit.

6. The system of claim 5 wherein the conduit is axially aligned with the first well opening.

7. The system of claim 1 wherein the second multi-well plate defines one or more of second wells having openings therein, a portion of the one or more of the first wells of the first plate being configured to be received within the openings of the one or more of the second wells upon alignment of the first plate with the second plate.

8. The system of claim 1 wherein the one or more of the first wells of the first multi-well plate are open-bottomed and the one or more of the second wells of the second multi-well plate are close-bottomed.

9. The system of claim 8 wherein the one or more of the first wells are configured to couple with the one or more of the second wells.

10. The system of claim 1 wherein the one or more of the first wells of the first multi-well plate are open-bottomed, the open bottom comprising a beveled edge projecting into the opening.

11. The system of claim 1 further comprising plant growth nutrients within either the first or second wells.

12. A method for harvesting biological samples, the method comprising:
providing first and second complimentary multi-well plates, the first plate having one or more open-bottomed first wells, and the second plate having one or more second wells;
growing individual biological material within one or more of the first wells of the first plate, at least some of the material extending into one or more of the second wells of the second plate;
separating the individual biological material into first and second portions; and
providing at least some of the second portion of the individual biological material into the second wells while maintaining at least some of the first portion within the first wells.

13. The method of claim 12 further comprising axially aligning the one or more first wells with the one or more second wells.

14. The method of claim 12 further comprising:
coupling the first plate with the second plate; and
decoupling the first plate from the second plate prior to separating the individual biological material.

15. The method of claim 14 wherein the decoupling separates the individual biological material into first and second portions.

16. The method of claim 12 further comprising analyzing a plurality of the second portions of the individual biological material within the second wells.

17. The method of claim 12 wherein the growing comprises providing nutrients within either one or both of the first or second wells.

18. The method of claim 12 wherein the one or more of the second wells of the second plate are close-bottomed.

19. A pair of complimentary multi-well plates configured to couple in a stacked configuration, the pair comprising a top plate having one or more open-bottomed wells and a bottom plate comprising one or more close-bottomed wells.
